(19) United States
(12) Patent Application Publication
(10) Pub. No.: US 2011/0061025 A1
(43) Pub. Date: Mar. 10, 2011

(54) Auto Scroll In Combination With Multi Finger Input Device Gesture

(76) Inventors: Erin K. Walline, Pflugerville, TX (US); Orin Ozias, Austin, TX (US)

(21) Appl. No.: 12/554,317

(22) Filed: Sep. 4, 2009

(51) Int. Cl. G06F 3/048; G06F 3/033

(52) U.S. Cl. 715/830; 715/863

(57) ABSTRACT

A gesture based method for scrolling through a document. More specifically, the gesture based method for scrolling through a document includes an automatic scroll gesture so that a user does not need to perform multiple scroll gestures when scrolling through a document.

### BACKGROUND OF THE INVENTION

1. Field of the Invention

The present invention relates to the field of information handling systems and more particularly to input gestures used with information handling systems.

2. Description of Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

It is known to present information on a display device of the information handling system. It is also known to scroll through information presented on the display device. It is also known to implement scrolling through information presented on the display device via some form of figure gesture. For example, certain information handling systems enable a 2-finger scroll gesture. However, many known scroll gestures require multiple gestures when scrolling through a large document.

Accordingly, it is desirable to provide a method to enable an auto-scroll function in which a user does not need to perform multiple scroll gestures when scrolling through a document.

### SUMMARY OF THE INVENTION

In accordance with the present invention, a gesture based method for scrolling through a document is disclosed. More specifically, the gesture based method for scrolling through a document includes an automatic scroll gesture so that a user does not need to perform multiple scroll gestures when scrolling through a document. In certain embodiments, if a user is performing a multi-touch (e.g., 2-finger) scroll gesture, rather than having to repeatedly move, lift and move again, a quick flick (i.e. a light sharp jerky stroke) or movement at the end of the gesture initiates an automatic scroll option. The automatic scroll option is ultimately easier for an end user to navigate through a document compared to multiple scroll gestures.

More specifically, in one embodiment, the invention relates to a method for generating a screen presentation content change on an information handling system. The method includes generating a screen presentation, the screen presentation including presentation of a document; monitoring for a predefined automatic scroll input gesture; and, automatically scrolling through the document in response to detection of the predefined automatic scroll input gesture.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows block diagram of an information handling system having a system for automatically scrolling.

FIG. 2 shows a flow chart of the operation of the system for automatically scrolling.

FIG. 3 shows a diagrammatic representation of a touchpad in combination with an example screen presentation.

FIG. 4 shows a diagrammatic representation of a touchpad in combination with an example screen presentation with an example input gesture.

FIG. 5 shows a diagrammatic representation of a touchpad in combination with an example screen presentation content change in response to the example input gesture.

### DETAILED DESCRIPTION

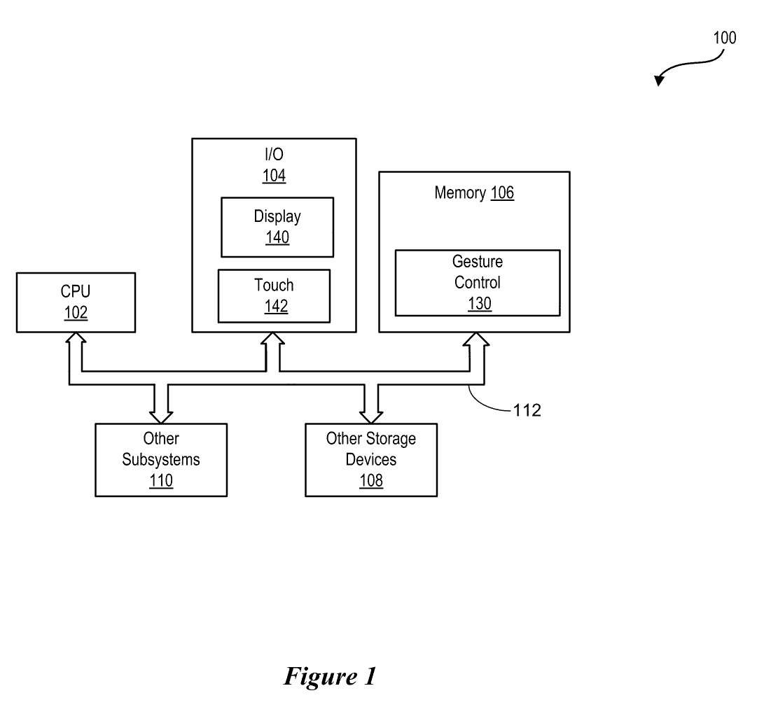

Referring to FIG. 1, a system block diagram of an information handling system 100 such as target information handling system 120 is shown. The information handling system 100 includes a processor 102, input/output (I/O) devices 104, such as a display, a keyboard, a mouse, and associated controllers, memory 206 including non-volatile memory such as a hard disk drive and volatile memory such as random access memory, and other storage devices 108, such as a floppy disk and drive and other memory devices, and various other subsystems 110, all interconnected via one or more buses, shown collectively as bus 112.

The memory stores a gesture control system 130 which includes instructions which are executed by the processor 102 to cause the information handling system to function in a prescribed manner. The I/O devices further include a display device 140 as well as a touch sensitive input device 142. The touch sensitive input device 142 may be a touch pad or may be a touch sensitive type display device.

For purposes of this invention, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

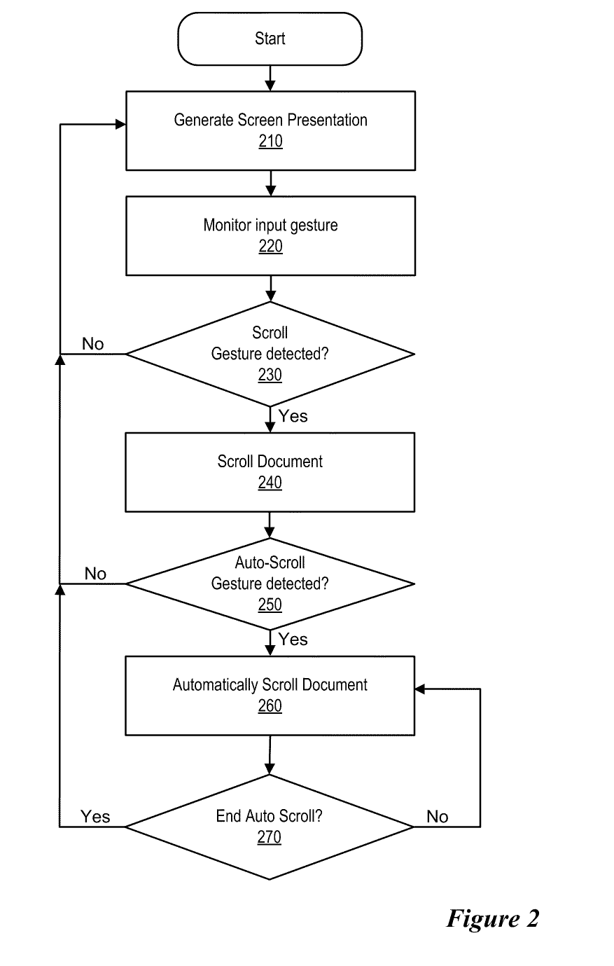

FIG. 2 shows a flow chart of the operation of the system for automatically scrolling 200 (e.g., the gesture control system 130). More specifically, operation of the system for automatically scrolling starts operation by generating a screen presentation at step 210. The screen presentation is presented on the display device 140 and can include a desktop as well as one or more icons presented on the desktop as well as one or more applications on the desktop. Next, the system monitors for a predefined input scroll gesture at step 220. In certain embodiments, the input gesture is a multi-finger gesture that is entered via the touch sensitive input device 142. If no predefined input scroll gesture is detected at step 230, then the system continues to generate the screen presentation at step 210.

If the predefined input scroll gesture is detected at step 230, then the system for automatically scrolling starts scrolling through the information presented via the screen presentation at step 240. As the information is being scrolled, the system for automatically scrolling 200 monitors for a predefined automatic scroll gesture at step 250. If the automatic scroll gesture is detected, then the system enters an automatic scroll mode of operation at step 260. If the automatic scroll gesture is not detected, then the system continues to generate the screen presentation at step 210. The system continues in the automatic scroll mode of operation until an end automatic scroll gesture is detected at step 270.

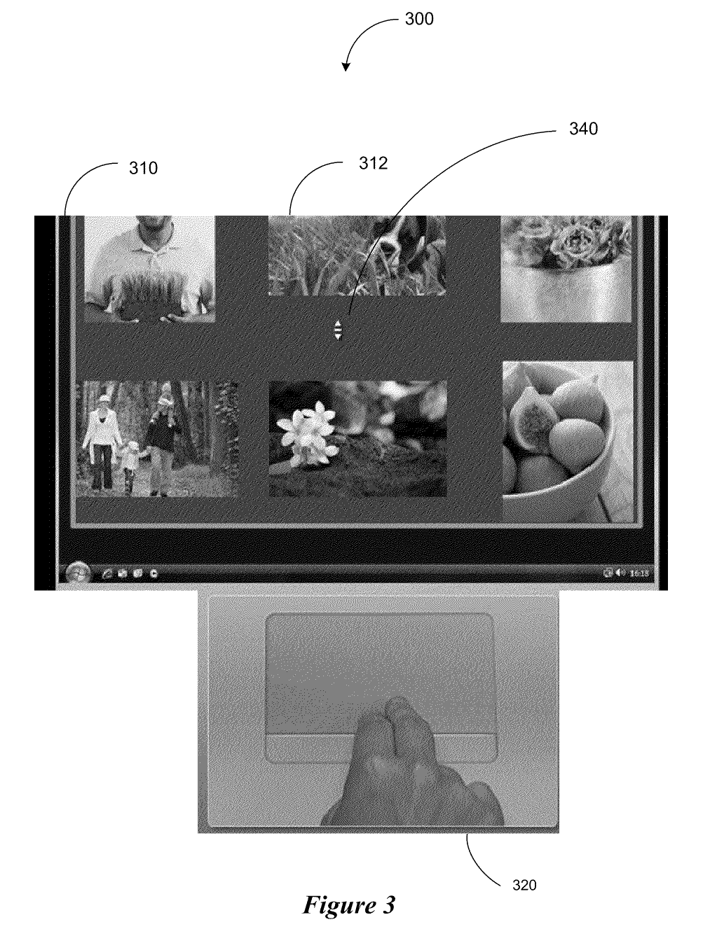

FIG. 3 shows a diagrammatic representation 300 of a touchpad in combination with an example screen presentation. More specifically, the diagrammatic representation 300 includes a screen presentation portion 310. The screen presentation includes a document presentation 312 as well as a task bar presentation 314. As is known in the art, the task bar presentation 314 can include a plurality of elements such as a start icon. The diagrammatic representation 300 further includes a touchpad portion 320 as well as a menu portion 330. The touchpad portion 320 may correspond to a touch pad input device 142. In this system, a multi-finger (e.g., a 2-finger) gesture causes the system for automatically scrolling to scroll through the document by moving the fingers across the touchpad. Upon detection of an automatic scroll gesture (e.g., a finger flick), the document continues to automatically scroll.

By using various gesture motion controls, a user can control whether the automatic scroll function moves vertically through the document (e.g., an auto Scroll V operation) relative to the orientation of the display device or moves horizontally through the document (e.g., an auto scroll H operation) relative to the orientation of the display device.

The screen presentation 300 also includes a scroll icon 340 which indicates that the scroll operation is occurring. The scroll icon 340 also indicates whether the scrolling is vertical (e.g., by the arrows being in a vertical direction relative to the display device orientation) or is horizontal (e.g., by the arrows being in a horizontal direction relative to the display device orientation)

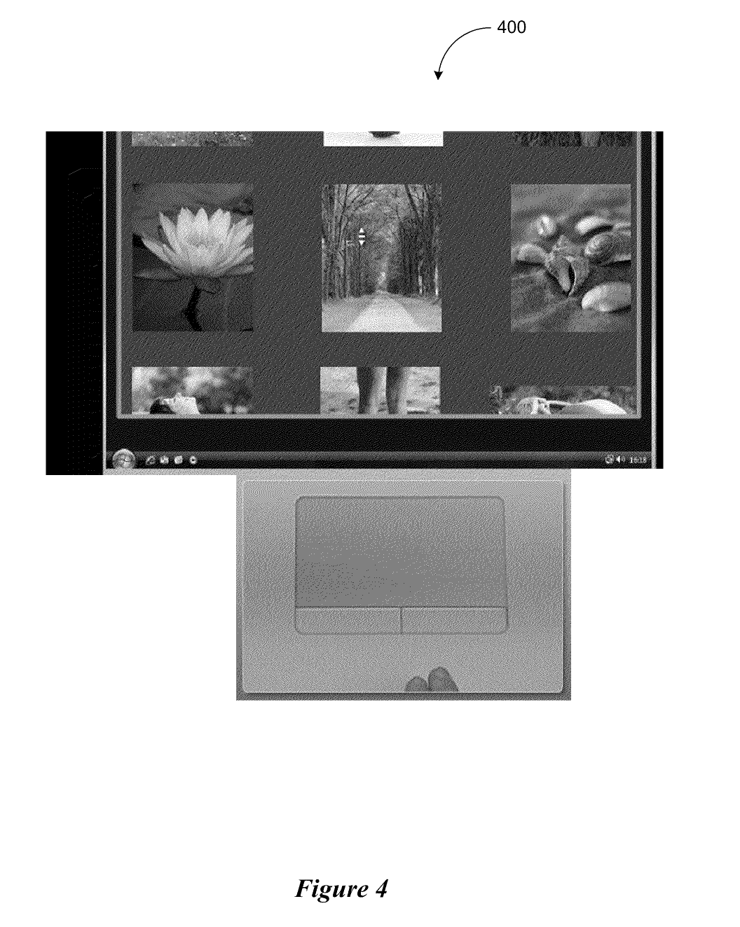

FIG. 4 shows a diagrammatic representation 400 of a touchpad in combination with an example screen presentation with an example input gesture. More specifically, upon entering the automatic scroll function, the screen presentation continues to scroll through the document even after the fingers are removed from the touchpad.

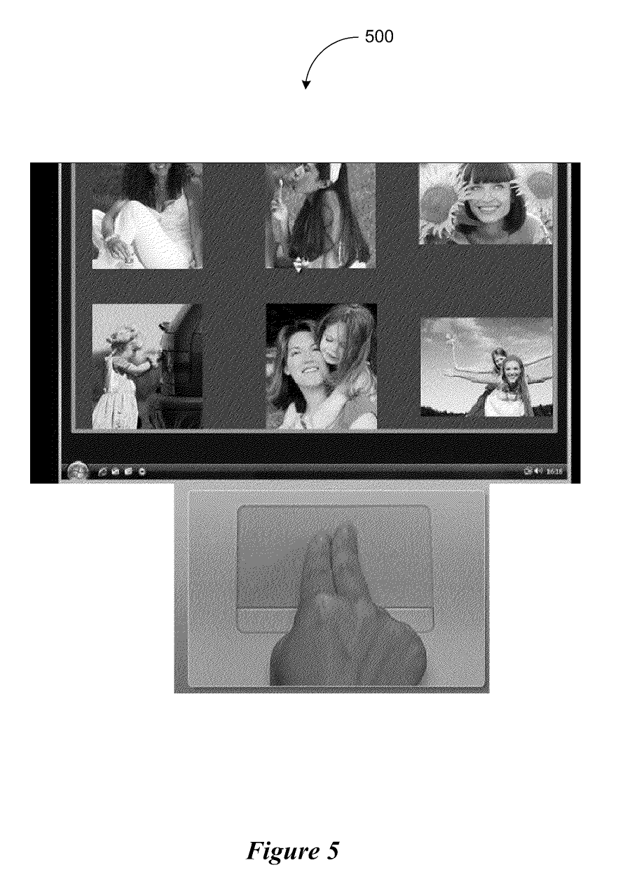

FIG. 5 shows a diagrammatic representation 500 of a touchpad in combination with an example screen presentation with an example input gesture. More specifically, after automatic scrolling is initiated, another gesture (e.g., a multi-finger touch) stops the automatic scrolling operation.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Also for example, the end automatic scroll gesture is one method of stopping the automatic scroll operation. Another method for accomplishing this operation would be to allow a decay or slow down in scrolling speed based on the velocity or acceleration of the flick or movement at the end of the input gesture that initiated the automatic scroll. (I.e., the automatic scroll would eventually stop on its own.) In certain embodiments, the method of ending the automatic scroll gesture may be user selectable in a user interface that controls touchpad functionality.

Consequently, the invention is intended to be limited only by the spirit and scope of the appended claims, giving full cognizance to equivalents in all respects.

What is claimed is:

1. A method for generating a screen presentation content change on an information handling system comprising:
generating a screen presentation, the screen presentation including presentation of a document;
monitoring for a predefined automatic scroll input gesture;
automatically scrolling through the document in response to detection of the predefined automatic scroll input gesture.

2. The method of claim 1 wherein:
the monitoring monitors a touch sensitive input device.

3. The method of claim 2 wherein:
the touch sensitive input device comprises at least one of a touch pad and a touch sensitive display device.

4. The method of claim 1 wherein:
the predefined input gesture comprises a multi-finger input gesture.

5. The method of claim 4 wherein:
the predefined input gesture comprises a flick.

6. The method of claim 1 wherein:
the screen presentation further comprises a scroll icon; and
the scroll icon indicates when the predefined automatic scroll input gesture has been detected.

7. An apparatus for generating a screen presentation content change on an information handling system comprising:
means for generating a screen presentation, the screen presentation including presentation of a document;
means for monitoring for a predefined automatic scroll input gesture;
means for automatically scrolling through the document in response to detection of the predefined automatic scroll input gesture.

8. The apparatus of claim 7 wherein:
the monitoring monitors a touch sensitive input device.

9. The apparatus of claim 8 wherein:
the touch sensitive input device comprises at least one of a touch pad and a touch sensitive display device.

10. The apparatus of claim 7 wherein:
the predefined input gesture comprises a multi-finger input gesture.

11. The apparatus of claim 10 wherein:
the predefined input gesture comprises a flick.

12. The apparatus of claim 7 wherein:
the screen presentation further comprises a scroll icon; and
the scroll icon indicates when the predefined automatic scroll input gesture has been detected.

13. An information handling system comprising
a processor;
a memory coupled to the processor, the memory storing a system for generating a screen presentation content change on the information handling system, the system for generating the screen presentation content change comprising instructions executable by the processor for:
generating a screen presentation, the screen presentation including presentation of a document;
monitoring for a predefined automatic scroll input gesture;
automatically scrolling through the document in response to detection of the predefined automatic scroll input gesture.

14. The information handling system of claim 13 further comprising:
a touch sensitive input device; and wherein,
the monitoring monitors a touch sensitive input device.

15. The information handing system of claim 14 wherein:
the touch sensitive input device comprises at least one of a touch pad and a touch sensitive display device.

16. The information handling system of claim 13 wherein:
the predefined input gesture comprises a multi-finger input gesture.

17. The information handling system of claim 16 wherein:
the predefined input gesture comprises a flick.

18. The information handling system of claim 13 wherein:
the screen presentation further comprises a scroll icon; and
the scroll icon indicates when the predefined automatic scroll input gesture has been detected.
